(19) United States
(12) Patent Application Publication
(10) Pub. No.: US 2006/0053073 A1
(43) Pub. Date: Mar. 9, 2006

(54) Investment grade managed variable rate demand notes

(76) Inventor: Joanne Marlowe-Noren, Wadsworth, IL (US)

Correspondence Address: Paul E Schaafsma;NovusIP, LLC, Suite 221, 521 West Superior Street, Chicago, IL, 60610-3135, US

(21) Appl. No.: 11/253,337

(22) Filed: Oct. 19, 2005

Related U.S. Application Data
(63) Continuation-in-part of application No. 10/400,211, filed on Mar. 27, 2003.

(51) Int. Cl. G06Q 40/00

(52) U.S. Cl. 705/35

(57) ABSTRACT

A financial instrument in accordance with the principles of the present invention permits a dedicated pool of debt capital to be actively deployed without the introduction of a third party source of security or collateral to cover the principal portion of funds being deployed as a predicate to effectuating those investment operations. The dedicated pool of debt-capital can be used for the purposes of permitted asset management without a subsequent deployment of available note proceeds to an underlying commercial project or investment. A financial instrument in accordance with the principles of the present invention standardizes the format, pricing, practice, and methodology of raising debt capital in the capital markets. Thus, a financial instrument in accordance with the principles of the present invention creates an environment that is conducive to the direct and consistent correlation of the institutional short-term investment market to the alternative investment or hedge fund market, thereby potentially fostering the creation of a new debt-based asset class that would produce a means of indexing and regularizing the alternative investment or hedge fund market within the investment marketplace.

### RELATED APPLICATION

This application is a continuation-in-part of U.S. patent application Ser. No. 10/400,211 titled “INVESTMENT GRADE COLLATERALIZED VARIABLE RATE DEMAND NOTES” filed on 27 Mar. 2003.

### FIELD OF THE INVENTION

The present invention relates to demand notes and similar financial products.

### BACKGROUND OF THE INVENTION

The use of Variable Rate Demand Notes (“VRDNs”) as a tool for raising debt in the capital markets for the benefit of corporate and municipal entities has been popularized during recent years. VRDNs provide an ability to marry long-term debt and finance commitments with a short-term interest rate. Use of VRDNs has been further enhanced by certain regulatory dictates that create a beneficial environment for the sale and placement of financial products having characteristics consistent with traditional VRDNs.

The VRDN has found its primary application in the commercial debt market by demonstrating its pricing superiority over other types of corporate debt securities. In its traditional form, the VRDN effectively competes with bond vehicles and traditional term loans in support of particularized commercial ventures or projects. It demonstrates how banking institutions and underwriters may be utilized in an innovative manner to create and enhance a financial instrument that can be sold widely into the capital marketplace via private placement and remarketing agreements.

Recently, as a means of improving upon the proven successes of the VRDNs, a Collateralized Variable Rate Demand Note (“CVRDN”) has evolved. CVRDNs can be sold or placed with money market funds, investment finds, and virtually any other institution that have an interest in obtaining investment grade financial instruments meeting certain investment criteria to which traditional VRDN's subscribe. The sale or placement of CVRDNs permits the issuer of the note series to raise a pool of debt capital in support of a not-yet-specifically-identified series of projects having a common industry theme, such as, for example real estate investment, equipment finance, asset-based lending, etc. In short, both the VRDN and CVRDN create a foundation upon which traditional bank underwriting procedures may be openly coordinated with the institutional capital markets in order to access a pool of additional capital that otherwise would not have been accessible. This, in turn, brings additional capital to the commercial marketplace.

Specifically, in today's United States-based institutional capital markets, institutional investors purchase financial products in substantial “blocks”. The credit rating of the instrument being acquired and the yield thereon are looked upon as the criteria upon which a determination to make an investment is afforded. An institutional investor is not inclined to undertake an underwriting process to determine the credit-worthiness of an investment opportunity. In addition, such an investment methodology would be both impractical and cost and time-prohibitive to investors in the capital markets. Instead, the institutional capital markets rely on investment bankers and underwriters to prepare, consolidate, package, and arrange for the rating of proposed investments prior to the investor's review and consideration of such for inclusion in its portfolio.

Through the use of VRDNs in their prior art incarnation, as well as CVRDNs as an improvement thereon, investment grade commercial banks are able to: identify projects or borrowers which they believe to be respectively credit worthy in their own right; apply standard underwriting methodologies of the commercial bank to review, evaluate, and package each such subject project or borrower; approve such project for credit; provide credit to the subject project or borrower in the form of a specifically formatted letter(s) of credit covering either the interest or principal component of the note being issued rather than in the form of a credit line or loan; attach its letter of credit to the issuance of a specific note series for the benefit of the note issuer such that the letter of credit enhances the credit worthiness of the notes being issued, normally causing the credit rating of the debt obligations of the underwriting institution to be passed through to the notes themselves; and facilitate or otherwise aid in the sale, placement, and remarketing of the note series with institutional capital markets investors from whom the actual debt proceeds will be raised.

Ultimately, by utilizing VRDNs or CVRDNs as the basis to raise debt capital, all parties to the transaction benefit. For instance, the borrower may be seeking finance that exceeds traditional lending limits or is otherwise unsuitable for underwriting on a cash loan or credit line basis; however, such debt may well be available directly from the capital markets and then subsequently syndicated by the note issuer/borrower amongst a series of participating underwriting banks. Alternatively, the borrower may benefit from advantages associated with qualifying for short-term, weekly adjustable interest rates as customarily are available and applied to a properly commercially underwritten VRDN or CVRDN. The use of either a VRDN or CVRDN affords the borrower the opportunity to take advantage of short-term interest rates while, via the utilization of a remarketing agreement with a suitable securities remarketing agent for the duration of a note term, obtaining a long-term financing commitment as facilitated by the participating commercial banks/underwriters.

The commercial bank that is underwriting the project or borrower also benefits. For instance, the commercial bank makes certain fee income related to the underwriting of the borrower's project or operation. For example, the commercial bank likely issues the interest letter of credit against cash or other collateral deposited with it for the duration of the note term. The commercial bank also may elect to underwrite the borrower's underlying project directly and cause the issuance of a letter of credit securing the principal portion of the notes. The commercial bank further may place the notes in the institutional capital markets and, in some cases, may also remarket the notes throughout the note term. Additionally, from time-to-time during the lifecycle of a commercial bank it is more advantageous to generate and reflect a higher percentage of fee income on the bank's financial statements. It is at those times that a bank's participation in a VRDN or CVRDN credit underwriting becomes even more beneficial. Specifically, a bank that is underwriting a project through the use of a letter of credit will receive annualized fees in exchange for the issuance of that letter of credit; in a traditional term loan, however, the bank only generates interest spread income. Dependent upon the current motivations of the bank, again, the VRDN or CVRDN can be an attractive credit tool to a participating underwriting bank or financial institution.

Finally, the institutional capital market investor benefits from the acquisition of the notes. For instance, the institutional capital market investor has available to it certain highly rated short-term investments which by regulatory guidelines or by its own investment requirements, it must maintain with respect to its portfolio. Specifically, the typical VRDN or CVRDN investors are money market funds, and to a lesser extent, corporations, trust departments, and high net worth individuals. Of these, money market funds are generally required under the Securities and Exchange Commission Investment Company Act to invest in high-quality, short-term obligations bearing interest at a rate calculated to give obligations purchased a market value of par. The hybrid nature of VRDNs and CVRDNs makes this instrument attractive to fill this market need: the credit quality of the commercial bank/underwriter that issued the respective letters of credit that supports either the interest and/or principal payments due under the notes is customarily of high quality and readily acceptable to the subject buyers.

In light of the foregoing, there is no doubt a benefit to the continuing presence of the VRDN in the debt markets in their prior art incarnation and, more recently, the advent of the CVRDN as an improvement thereupon. However, prior art VRDNs contain several aspects that limit their use to funding projects that are: candidates for traditional term loan underwriting by a conventional commercial bank, specifically pre-identified and credit underwritten in advance of VRDN issuance, and usually financed via a single VRDN series issuance and enhanced via a single underwriter.

Specifically, the type of subject matter investment that is or can be converted to a VRDN placement generally exhibits the same credit worthiness as any other project which may be candidate for traditional term loan underwriting by a conventional commercial bank. Such baseline credit criteria restricts the VRDNs from use in support of more speculative/higher return projects, non-speculative but transaction-based projects or other projects which may lack traditional collateral structures or historically definable revenue typically deemed acceptable to commercial banks in their standard underwriting models.

Second, under some current circumstances in which VRDNs are issued, the underlying project must be identified with specificity before the underwriting process may begin. This is a reasonable predicate to the underwriting of a project through traditional commercial means, but eliminates the possibility of utilizing VRDNs as a means to raise debt capital by a fund, cash manager or investment manager in support of an investment pool or fund operating profile. This holds even if general investment criteria for subsequent investment are consistent with policy of the underwriter or based on an opportunistic investment philosophy, such that the intended use of funds may not be known or identified with particularity prior to the date of sale of the VRDNs.

Likewise, in looking at a CVRDN, although significantly more flexible than a VRDN in its uses and capital deployment requirements, the CVRDN still has certain limitations that tailor its application to only certain areas of operation in the commercial marketplace. Particularly, a CVRDN, like a VRDN, has its highest and best use in creating a more cost-effective basis to provide debt capital in support of projects that meet certain minimum credit criteria and are therefore considered commercially underwritable projects or operations. Different from the VRDN, however, the CVRDN incorporates a precursor note phase (a convertible, cash-backed phase) upon its issuance that enables an issuer/borrower to accumulate a pool of debt capital for a general commercial operating purpose prior to specifically allocating the note proceeds. Such general commercial operating purpose can be a series of permitted and designated projects that qualify under the CVRDNs use of proceeds profile as set forth in its offering or subscription documentation. Such an ability to raise low-cost debt capital that can be held on deposit by the CVRDN issuer/borrower pending the borrower's determination as to how those proceeds can be spent is a critical improvement upon the prior art VRDN. Thus, the CVRDN issuer/borrower is afforded a significant increase in investment flexibility and capital management options.

Interestingly, however, the VRDN and the CVRDN—despite an increased flexibility in funds management and investment determination—are both still generally impractical for use by a category of financial institutions such as alternative investment firms, cash or asset management firms, hedge funds, and/or securities or commodities trading companies. These firms, when operated prudently, have clearly definable asset management and investment strategies that are, upon examination, quantifiable and trackable. These firms deal in financial instruments and other collateral having real and determinable market values. They are managed by highly qualified, licensed, and regulated professionals in the capital markets, commodities, and investment markets. These firms are subjected to stringent risk management, actuarial, and regulatory analysis on a consistent basis.

The risks and returns associated with operations in these highly fluid and specialized areas of financial management and investment, however, generally fall outside the underwriting scope and capability of most conventional commercial and credit underwriters due to the degree of sophistication of such companies. Thus, the ability to take advantage of the low-cost debt that is presently available to more mainstream issuers/borrowers through the use of the VRDN or CVRDN is limited if not wholly restricted by qualified investment professionals in the aforementioned areas of operation. Even with the recent introduction of the CVRDN, there still remains substantial room for improvement on this type of financial product.

What is thus needed is a new financial instrument that can be applied to a broader scope of funds usage and investment than that which is acceptable under traditional commercial bank underwriting criteria. Such new financial instrument preferably can be applied to directly place relatively inexpensive debt capital under an issuer's/borrower's management in support of the creation, establishment, growth or development of an investment fund, cash or asset management portfolio, hedge fund or trading firm. Such new financial instrument would promote higher volumes of low-cost institutional debt capital arising from the capital markets in support of this category of financial institutions including cash and asset managers, alternative investment firms, hedge funds, or securities or commodities trading professionals that otherwise would not customarily have such cost-effective debt finance available. Such new financial instrument would create an opportunity for this category of financial institutions such as cash and asset managers, alternative investment firms, hedge funds, or securities or commodities trading professionals to raise large lump-sums of capital that are available for subsequent active investment or trading. Such new financial instrument would help this category of financial institutions such as cash and asset managers, alternative investment firms, hedge funds, or securities or commodities trading professionals to train themselves away from the granular practice of raising significant volumes of hard-to-raise, equity-based capital in small increments through the sale of limited partnership interests or other similar share or participating ownership-based practices. Such new financial instrument would foster the ability of this category of financial institutions such as alternative investment firms, cash or asset management firms, hedge funds, and/or securities or commodities trading companies as the note issuer to set minimum and maximum performance benchmarks for their respective operations that will in turn create far greater profitability to the issuers/borrowers/operators themselves than present practices permit. Lastly, such new financial instrument will constitute an investment vehicle that meets the credit criteria of the conventional VRDN and CVRDN investors such that it permits investors, as note subscribers, that otherwise may not be candidate to participate in the profitability of for example alternative investment firms, cash or asset managers, hedge funds, or securities or commodities trading companies to participate without incurring the customary risks inherent in a direct equity or debt-based investment.

### SUMMARY OF THE INVENTION

A financial instrument in accordance with the principles of the present invention utilizes a collateral structure consisting of a cash-secured financial instrument. The cash secured financial instrument of the present invention is supported by a specially designed liquidity facility and principal protected collateral structure, such that the aggregate face value of the financial instruments is secured by highly rated collateral. A financial instrument in accordance with the principles of the present invention may incorporate an underlying structured note product to be issued by an investment grade commercial bank or institution to indirectly secure the principal portion of the note. This contributes to a more meaningful and aggressive risk management strategy related to the investment of note proceeds by the issuer/borrower. A financial instrument in accordance with the principles of the present invention secures interest payments due there under via the issuance of an interest letter of credit issued by an investment grade commercial bank or institution on behalf of the issuer/borrower. A financial instrument in accordance with the principles of the present invention can be issued in a consistent investment grade format, ratable by one or more recognized credit rating agencies, and, therefore, takes advantage of the well established market operations associated with the sale and placement of prior art VRDNs.

A financial instrument in accordance with the principles of the present invention is issued in a manner consistent with current pricing and interest models as employed in prior art VRDN issuances. A financial instrument in accordance with the principles of the present invention introduces a premium payable to the noteholder/subscriber based upon the annualized performance of the note issuer/borrower's underlying performance. A financial instrument in accordance with the principles of the present invention can be placed and remarketed in accordance with accepted practices and methodologies developed and employed by qualified placement firms and agents related to prior art VRDNs, thus broadening the audience of potential investors in the financial instrument.

A financial instrument in accordance with the principles of the present invention improves upon the methodologies and practices employed in the operation of the convertible, cash-backed phase of a CVRDN to create a dedicated pool of debt-capital. A financial instrument in accordance with the principles of the present invention permits the debt capital to be actively deployed without the introduction of a third party source of security or collateral to cover the principal portion of funds being deployed as a predicate to effectuating those investment operations. The dedicated pool of debt-capital can be used for the purposes of permitted asset management without a subsequent deployment of available note proceeds to an underlying commercial project or investment. A financial instrument in accordance with the principles of the present invention standardizes the format, pricing, practice, and methodology of raising debt capital in the capital markets. Thus, a financial instrument in accordance with the principles of the present invention creates an environment that is conducive to the direct and consistent correlation of the institutional short-term investment market to the alternative investment or hedge fund market, thereby potentially fostering the creation of a new debt-based asset class that would produce a means of indexing and regularizing the alternative investment or hedge fund market within the investment marketplace. A financial instrument in accordance with the present invention can be utilized as the source of a new set of derivative instruments, such as premium strips for example, that will increase the tradeable nature and pricing of the financial instrument.

### BRIEF DESCRIPTION OF THE DRAWINGS

FIG. 1 is a methodological schematic overview of a subscription through retirement process in accordance with the principles of the present invention.

FIG. 2 is a methodological schematic showing details of the operation of the reserved tender advance facility in settlement of a permitted tender up to the principal value of outstanding financial instruments that fail to be timely remarketed in accordance with the principles of the present invention.

FIG. 3 is a methodological schematic that shows the relationship between the investment operation and the underlying security structure incorporating both the reserved tender advance facility and a structured note product in the event of investment devaluation in accordance with the principles of the present invention.

### DETAILED DESCRIPTION OF THE PREFERRED EMBODIMENTS

The financial instrument of the present invention enables the creation of a flexible debt instrument which, as supported by a series of specifically coordinated financial mechanisms, complies with purchasing norms of established segments of the institutional capital markets with respect to debt instruments. The financial instrument of the present invention enables the creation of an investment grade debt instrument which is suitable for purchase by institutional investors that subscribe to investment guidelines set forth under the Investment Company Act under the jurisdiction of the Securities and Exchange Commission or otherwise subscribe to short-term investment criteria in which a high-degree of investment liquidity is required. The instrument is ratable by Standard & Poor's Ratings Services, 55 Water Street, New York, N.Y. 10041 (“S&P”), Moody's Investors Service, Inc., 99 Church Street, New York, N.Y. 10007 (“Moody's”) or some other comparable credit rating agency.

By employing a financial instrument of the present invention, an issuer can raise lower cost debt capital within the institutional capital markets in support of the operation and funding of a category of financial institutions such as an alternative investment fund, cash or asset management portfolio, a hedge fund, or securities or commodities trading strategy within the scope of generally defined investment or operations criteria. For the purpose of ease of discussion and not as a limitation, such category of financial institutions such as an alternative investment fund, cash or asset management portfolio, a hedge fund, or securities or commodities trading strategy are referred to herein as “alternative financial institutions”. The generic investment criteria are disclosed to the candidate investors at the time of sale or placement of the financial instruments within the context of a note framework that does not translate investment risk to the investor. The generic investment criteria enables the selection and underwriting of certain particular investments, transactions or trading strategies which meet the eligibility and credit criteria as established and disclosed by the issuer to certain investment grade credit underwriters. The implementation of such investments, transactions or trading strategies occurs at the discretion of the issuer after the sale of the financial instruments in the capital markets and independent of any additional transaction or operating risk to the investor or noteholder.

A financial instrument of the present invention combines the advantages of a traditional, rated, investment grade security such as a VRDN and CVRDN with the advantages of certain trust and reserve mechanisms, producing a circumstance which permits debt capital to be raised in volume to enable alternative financial institutions to perform certain unspecified alternative investments, cash or asset management functions, hedge fund operations, or securities or commodities trading strategies rather than for the purposes of underwriting specific project-based applications. The financial instruments of the present invention are uniformly formatted amongst themselves such that a standardized debt, security or financial instrument is created which need not materially vary based upon the nature of the underlying investment operations or the intended use of proceeds derived from the sale or placement of the financial instrument to the investor. A financial instrument of the present invention will pay a premium based upon performance of the issuer during the term of the instrument in addition to scheduled interest payments due pursuant to the conditions of the financial instrument. The financial instruments of the present invention will foster the establishment of a new class of financial instruments that correlate the pricing of institutional debt capital investments in alternative financial institutions, and further correlating certain risk management features of the financial instrument with performance premiums paid or otherwise assessed on the financial instruments.

A financial instrument in accordance with the principles of the present invention improves upon the methodologies and practices employed in the operation of the convertible, cash-backed phase of a CVRDN to create a dedicated pool of debt-capital. Specifically, a financial instrument in accordance with the principles of the present invention permits debt capital to be actively deployed into a variety of investment operations within the alternative investment marketplace without the introduction of a letter of credit to cover the principal portion of finds being deployed as a predicate to effectuating those investment operations. By contrast with a prior art VRDN or a CVRDN, a financial instrument in accordance with the principles of the present invention does not require or call for a commercial underwriter to approve and underwrite an underlying commercial project or investment as a means of accessing the debt capital raised. Instead, the investment of proceeds is a permitted function that is performed and administered within a managed portfolio account, with no need for proceeds to be directed outside the scope of the trust infrastructure for investment. A financial instrument in accordance with the present invention brings all investment functionality within the scope of the Managed Portfolio Account, inclusive of the safekeeping of collateral or other eligible or permitted investments to be undertaken with proceeds derived from the sale of the instrument. A financial instrument in accordance with the present invention incorporates a coordinated set of investment risk management and collateral functions within the operation and administration of the Managed Portfolio Account that does not require a third party source of security or collateral, such as a letter of credit, for the principal portion of the financial instruments to be accessed and applied as intended in the offering documentation and disclosures.

The financial instruments of the present invention are ratable by a credit rating agency based upon the trust and reserve structures employed, the liquidity features of an underlying reserved tender advance facility covering up to the principal value of the outstanding financial instruments during their respective term, and the provision of an acceptable letter of credit covering interest payments payable during the term of the financial instruments. Thus, the financial instruments of the present invention raise placement efficiencies and create a foundation in the marketplace that is conducive to the volume placement, sale, and remarketing of the financial instruments. Particularly, the financial instruments of the present invention assure the suitability and marketability of the short-term nature of the instrument in a manner that meets the short-term investment requirements of the investor (comparable to a prior art VRDN or a CVRDN) while also accommodating the long-term debt requirements of the issuer under an operating profile which potentially provides greater flexibility as to use of proceeds by the issuer.

### EXAMPLE

For the purposes of explanation and not to narrow the scope of the present invention, in the following example a financial instrument in accordance with the principles of the present invention can be referred to as a Managed Variable Rate Demand Note (MVRDN). For the purposes of explanation and not to narrow the scope of the present invention, in the following example Managed Variable Rate Demand Notes (MVRDNs) are referred to as “Notes.”

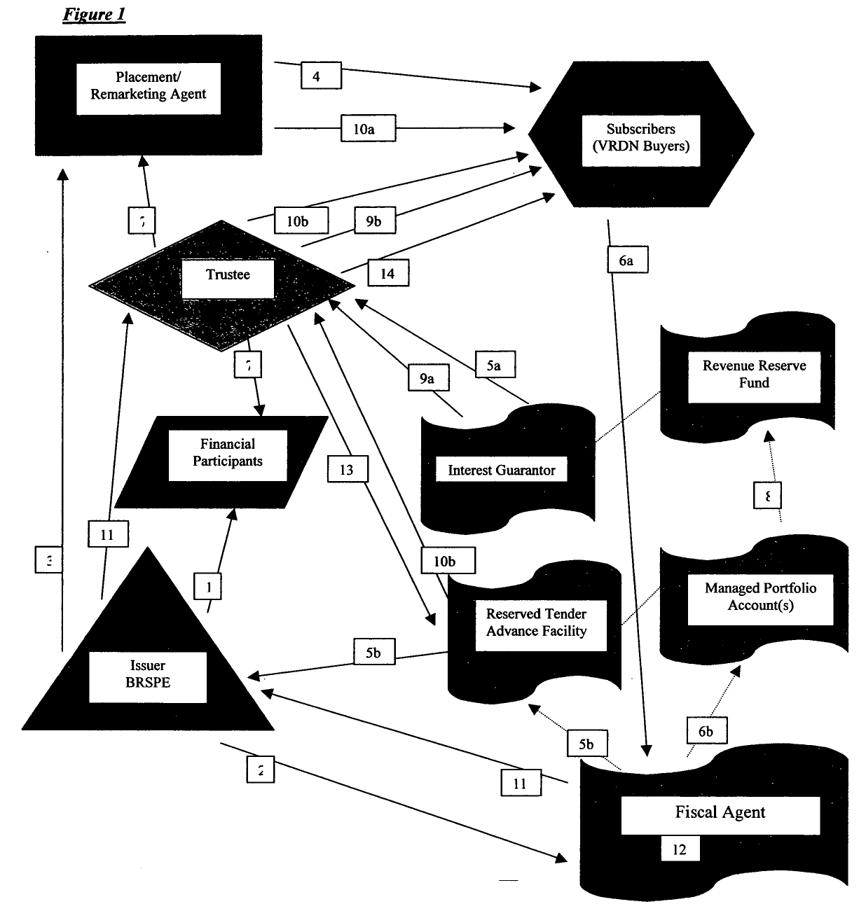

Referring first to FIG. 1, a methodological schematic depicting a general overview of a subscription through retirement process in accordance with the principles of the present invention is seen. A special purpose bankruptcy remote entity is created (“Issuer”) which issues the Notes and which is wholly owned by an alternative financial institution or such other operating entity which is responsible for the implementation of investment criteria or use of proceeds. In addition to issuing the Notes, the Issuer makes the offering for the purpose of attracting investment, and subsequently enables the management and implementation of the proceeds arising from the sale of the Notes in a manner consistent with investment criteria established related to that certain offering. The Issuer will, in preparation for issuance, engage (101) the necessary financing participants, inclusive of but not limited to an agent for placement of the Notes (“Private Placement/Remarketing Agent”), an entity responsible for the administration of the Notes (“the “Trustee”), and a banking institution as an extension of the Trustee for the purposes of administering the management of Note proceeds (the “Fiscal Agent”).

Particularly, the Issuer applies to and negotiates with a candidate Fiscal Agent (102) for the purposes of establishing and administering one or more interest bearing, depository/investment account(s) designated for the reservation and holding of funds in support of the operation of the Issuer's investment fund (the “Managed Portfolio Account(s)”) and a liquidity/credit facility secured by the Managed Portfolio Account that is established with a banking institution (the “Reserved Tender Advance Facility”).

The Issuer creates a document that provides the potential investor with a required description of and disclosure related to the nature of the Notes being offered for sale (“Offering Memorandum”). The Offering Memorandum, accompanied by any other offering documentation, inclusive of but not necessarily limited to certain requisite legal opinions required to complete the offering package, is tendered (103) by the Issuer to the Private Placement/Remarketing Agent for placement with qualified investors. The target market for the Notes consists of institutional investors (such as, for example, money market funds), corporations, trust departments and, to a lesser extent, high net worth individuals (collectively, the “Subscribers”). The Private Placement/Remarketing Agent is responsible for marketing the offering and preferably should have a close association with the institutional capital markets in the area of money market funds and other institutions which would fall under the Security and Exchange Commission Investment Company Act or otherwise be candidate VRDN purchasers. The Private Placement/Remarketing Agent markets (104) the Offering to qualified Subscribers.

The Subscriber provides advice of its intended purchase of the Notes to the Private Placement/Remarketing Agent. Upon notice from the Private Placement/Remarketing Agent of the pending closing of the Offering, the issuer of a letter of credit covering the interest portion of the Notes (the “Interest Guarantor”) (for example, a division or office of the institution acting as Fiscal Agent or such other institution as may be agreed) executes requisite security agreements with the Issuer against certain cash or other collateral acceptable to the Interest Guarantor sufficient to secure the issuance of the Letter of Credit covering interest. At the option of the Interest Guarantor, it may also or alternatively elect to secure itself against the minimum scheduled revenue streams arising from the operation of the Managed Portfolio Account(s). The Issuer instructs the issuance and delivery (105a) of a letter of credit covering the agreed minimum interest on the Notes (“Interest Letter of Credit”). The Interest Letter of Credit is usually in the form of a ‘direct-pay’ letter of credit, although a professional skilled in the art may elect to utilize another letter of credit form. The Interest Letter of Credit secures the payment of interest due under the Notes and is deposited to the designated safekeeping account (“Custodial Account”) established at the Trustee's institution. It is issued by an institution deemed acceptable by the Trustee pursuant to minimum credit requirements which meet credit rating criteria as determined by the rating agency which rated the Notes. The Trustee accepts, holds, and will subsequently draw upon the Interest Letter of Credit for the ultimate benefit of the Subscribers.

The Interest Letter of Credit will be issued (105a) in favor of the Trustee minimally covering the agreed variable rate interest payable on the Notes which is priced at a minimum of 5-10 basis points over 30-day London Interbank Offered Rate (LIBOR). For the purposes of example and not limitation, the face value of the Interest Letter of Credit may be issued for a face value equal to thirty-five (35) day's interest on the principal portion of the aggregate amount of Notes being issued, based upon a 365-day year and calculated at a cap rate of, for example, twelve percent (12%) per annum.

Concurrent with the issuance of the Interest Letter of Credit, the Fiscal Agent (or such other institution that may be deemed acceptable by the Trustee) will execute and organize (105b) the Reserved Tender Advance Facility. The Reserved Tender Advance Facility will be the basis to provide certain short-term liquidity covering the principal portion of the Notes upon an optional tender, acceleration or redemption of the Notes during their term. The Reserved Tender Advance Facility will be secured by the cash and investments held in the Managed Portfolio Account(s).

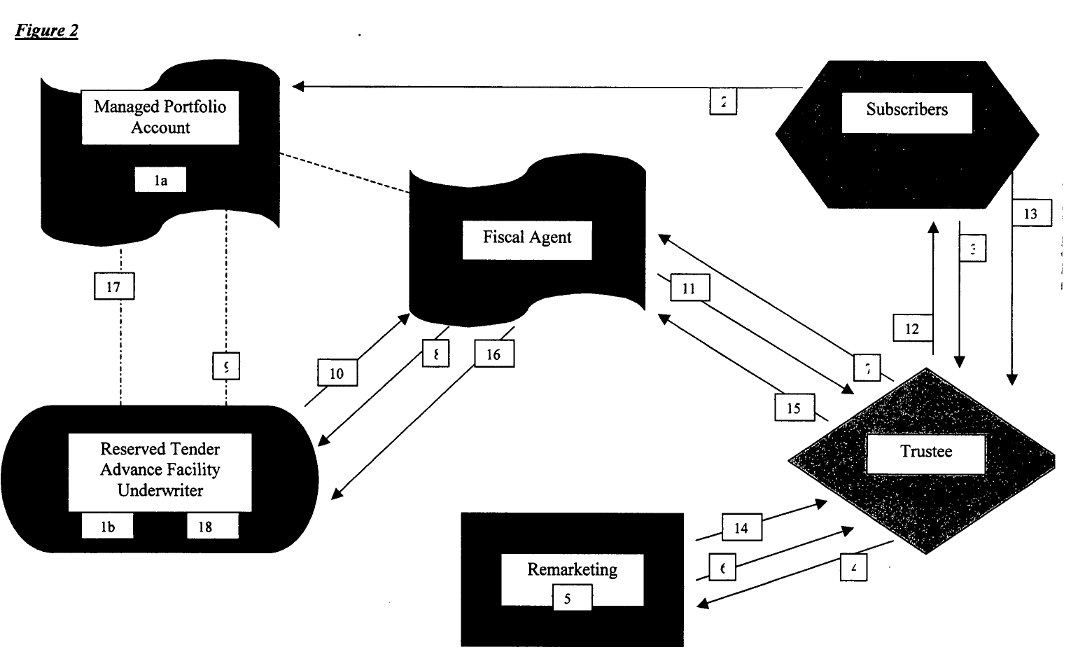

For the purposes of fiscally enhancing the operation of the Managed Portfolio Account and the Notes, one or more financial entities are engaged for the establishment of the Reserved Tender Advance Facility (“Facility Underwriter”). The Facility Underwriter may consist of a single banking institution, one or more banking institutions participating in a syndication, one or more insurance companies or reinsurers organized in relation to a liquidity or credit mechanism, or one or more institutions that are accustomed to providing similar liquidity facilities within the context of the operation of the capital markets (for example, an institution that customarily provides short-term share liquidity to closed-end mutual funds upon a redemption of mutual fund shares that is awaiting remarketing/resale). However, in general, there is a lead Facility Underwriter of sufficient credit quality to meet minimal rating criteria set forth by the nominated credit rating agency which subsequently rates the Notes. In one embodiment, the Facility Underwriter would also be acting as the Fiscal Agent. The Reserved Tender Advance Facility is established as the basis of credit enhancement of the Notes for the purposes of maintaining the investment grade rating thereof. The credit rating of the Facility Underwriter generally serves as the basis to enhance the rating of the Notes in order to meet minimum rating criteria as defined by market-related conditions for the sale of the Notes. Specific operations of the Reserved Tender Advance Facility are more completely described in reference to FIG. 2.

In the present example, the Subscriber acquires the Notes via electronic payment and book-entry delivery of the instruments (106a) with settlement therefore being directed to the Fiscal Agent. In the present example, the payment for the Notes is tendered directly to the Fiscal Agent for subsequent distribution to a designated Managed Portfolio Account(s) with the Fiscal Agent (or nominated satellite Fiscal Agent as may have been set forth in the Offering Memorandum). In one embodiment, the Fiscal Agent is a banking institution of sufficient credit quality to meet minimal rating criteria set forth by the nominated credit rating agency which rates the Notes and possesses certain trust powers that will permit it to act in a fiduciary capacity. Since the Note proceeds are the property of the Issuer (a bankruptcy-remote special purpose entity), the bankruptcy or insolvency of its parent (the operating company investing the Note proceeds) will not prevent the Note proceeds from being available to secure the Notes. The Note proceeds secure the principal portion of the Notes as further supported by the Reserved Tender Advance Facility.

The Trustee is designated as responsible for the administration of the Notes for the benefit of the Issuer and the holders of the Notes (the “Note Holders”) throughout the life of the Notes. The Trustee may be the trust division of the Fiscal Agent; however, for the purposes of this example, the Trustee is profiled as an independent institution. The Fiscal Agent acts to administer the Note proceeds on behalf of the Issuer and the Trustee by the establishment, maintenance, and management of the Managed Portfolio Account. The Managed Portfolio Account may be an interest-bearing account to be maintained at the Fiscal Agent's institution.

As referenced earlier, upon receipt of payment, the Fiscal Agent deposits (106b) Note proceeds to the Managed Portfolio Account. The Note proceeds serve as the basis to reserve the value of proceeds to cover any required payment of the principal portion of the Notes upon a mandatory or optional tender, acceleration or redemption of the Notes during their term. An entity (“Remarketing Agent”) is engaged at the time of offering for the remarketing or resale of any tendered Notes during the life of the Notes. As described in more detail with reference to FIGS. 2, in the event of a mandatory or optional tender of the Notes, the Remarketing Agent remarkets the tendered Notes to additional or replacement subscribers. The remarketing of the tendered Notes maintains the long-term integrity of the financing/proceeds made available to the Issuer upon the initial placement of the Notes.

Just prior to the time of sale/placement of the Notes, the Issuer shall cause to be deposited with the Trustee an amount of funds sufficient to cover placement fees and any other costs associated with the issuance and offering of the Notes so that the fees may be made payable at closing while still permitting the Note proceeds to be deposited into the Managed Portfolio Account. Against funds deposited by the Issuer, scheduled fees, commissions, and royalties payable at closing are paid (107) by the Trustee on behalf of the Issuer and disbursed in favour of the entities entitled thereto.

Earnings generated on the assets held in the Managed Portfolio Account(s) may be deposited (108) to a Revenue Reserve Account with the Fiscal Agent. The Revenue Reserve Account acts as a means of supporting monthly interest payment reimbursements as scheduled and payable under the Notes via the Interest Letter of Credit, and/or reserving an amount of supplemental revenue participation or ‘premium’ for distribution in favour of the Subscribers or such other entities as may be entitled thereto by agreement with the Issuer. By way of example and not limitation, the nature of investments or transactions undertaken with those Note proceeds which are placed on deposit in the Manage Portfolio Account(s) (the “Managed Note Proceeds”) may include any approved, investment operation or project which does not contradict the Issuer's Reserved Tender Advance Facility agreement with the Facility Underwriter, including, but not limited to any variety of combinations or strategies calling for the purchase, sale, repurchase, or trade of U.S. Federal Securities, currencies, options, futures, approved derivatives, and/or equities. The Issuer (by instruction to the Fiscal Agent) manages Managed Note Proceeds deposited to the Managed Portfolio Account for direct and specific investment to scheduled securities, financial instruments or investments that then constitute a portion of the managed portfolio. The scheduled investments are effected in accordance with the investment eligibility requirements as set forth in the Offering Memorandum.

Pursuant to the interest payment schedule agreed under the terms and conditions of the Notes, the Trustee commences scheduled draws (109a) of the required interest payments against the Interest Letter of Credit and subsequently disburses (109b) the interest payments to the Subscribers. Although, in the present example, a book-entry only system is utilized for settlements, a professional skilled in the art will recognize, in lieu of the book-entry only system, physical Note certificates may be issued. Each interest disbursement will be covered, reimbursed or otherwise offset by draws against funds or collateral posted by the Issuer in support of the issuance of the Interest Letter of Credit, independent reimbursement of the amount drawn via deposit of funds to the Interest Guarantor or the deposit of certain minimum scheduled earnings arising from the operation of the Managed Portfolio Account as such is agreed with the Fiscal Agent.

As and when required upon an optional tender of the Notes by the Subscribers as permitted under the terms of the Notes, the Remarketing Agent shall undertake to remarket (110a) the tendered Notes to alternative Subscribers. By successfully remarketing tendered Notes, the remarketing proceeds are available to repurchase the Notes and, therefore, the long-term integrity of the Managed Portfolio Account(s) is maintained throughout the term of the Notes due to the fact that there is no need for the interim liquidation of any portion of the managed portfolio. Like the prior art VRDN and the CVRDN, a basic characteristic of the MVRDN permits the Subscriber to ‘put’ the Notes back to the Issuer upon notice of, for example, seven (7) day's. It is this component that enables the financial instrument of the present invention to benefit from weekly pricing of its interest rate. It is also this option to tender the Notes that requires the incorporation of a consistent remarketing mechanism to assure that the remarketing or reselling the Notes at their minimum par or principal value (or such other value as may be dictated in part by market pricing of the Premium component of the Notes, as such term is defined below) is assured throughout the Note term. However, failure of the Remarketing Agent to timely remarket the tendered Notes will result in the activation of the Reserved Tender Advance Facility (110b) as established or administered by the Fiscal Agent. Activation of the Reserved Tender Advance Facility causes the principal portion of tendered Notes to be offset by a draw by the Trustee under the Reserved Tender Advance Facility, and the integrity of the Managed Portfolio Account(s) continues to be maintained even though remarketing efforts failed or were delayed beyond the required settlement date. As the basis to further offset risks associated with a failure or significant delay of the Remarketing Agent to remarket the Notes, the Issuer may elect to engage a third party insurer for the purposes of establishing a certain insurance policy to reimburse the Reserved Tender Advance Facility in the event of a failed remarketing.

During the term of the Notes and pursuant to an agreed periodic profit participation or ‘premium’ schedule, the Issuer shall (via the Trustee) disburse (111) any supplemental Note earnings (“Premium”) beyond interest payable in favour of the Subscribers and/or any other entities entitled to participate therein over a prescribed term. The Premium will be calculated as an additional percentage of earnings generated by the Issuer from the investment strategy(s) undertaken with the Managed Note Proceeds. Since the Issuer has established a means of limiting principal risk to the investor and caused the Note to meet certain minimum rating criteria as established by the rating agency that has rated the Notes, the Issuer may wish to establish a Premium ‘cap’ that will limit the additional Premium payable to the Note Holder resultant from its participation in investment profits after note interest is paid, provided that the Notes have remained in good standing and current throughout their term. The ‘capping’ of Premium payable has several short-term advantages to the Issuer such as for example increasing net retainable earnings or yield generated on the managed portfolio, enhancing overall profitability of operations, and limiting revenue outflows.

Taking a longer term view forward over the course of the Note term, as the use of the financial instrument of the present invention becomes more widespread, the operation of a Note without a Premium ‘cap’ may ultimately prove more advantageous to the Issuer by providing greater market opportunities and after-market flexibility. By not limiting the potential rate of Premium payable to the Subscriber or Note Holder, but rather establishing a guideline for the calculation of Premium from one Note issuance to another at a lower percentage ratio of performance earnings or rate of return on the operation of an alternative investment than present practices permit, it is reasonable that an index for this new financial instrument may more readily evolve. The advent of an MVRDN index could foster a far more liquid and tradable market for the financial instrument and offer a standardized after-market Premium-based pricing platform for Notes. In such case, it may not just be the interest coupon and rating that weigh into Note pricing upon initial placement and remarketing, the historical or anticipated Premium payable arising from the performance of the underlying managed portfolio as administered by the particular Issuer (or parent to the Issuer, as the case may be) also may weigh into Note pricing. This creates a potential for far greater and more widespread market opportunities and applications for the financial instrument than may initially be perceived.

At the maturity date of the issuance, in the event of a mandatory or optional tender or upon advice to the Trustee of the intention of the Issuer to prepay the outstanding Notes, the Fiscal Agent will cause the liquidation of the managed portfolio. An amount of cash proceeds equal to the principal portion of outstanding Notes is available for disbursement from the Managed Portfolio Account in favour of the Trustee for the benefit of the investors (112). The Trustee will either collect the principal portion of the Notes due from the Issuer directly, cause a draw (113) against the Managed Note Proceeds from the Fiscal Agent to cover the outstanding principal portion of the Notes then outstanding, or cause (113) a draw under the Reserved Tender Advance Facility to cover the balance of any principal portion of the Notes then outstanding that were not otherwise covered by Managed Note Proceeds. The Trustee subsequently and timely disburses (114) an amount of funds sufficient to retire the principal portion of the Notes due concurrent with the disbursement of any final interest payments due as drawn under the Interest Letter of Credit. The Notes are thereafter paid and cancelled.

Referring now to FIG. 2, a methodological schematic showing details of the operation of the Reserved Tender Advance Facility in settlement of a permitted tender up to the principal value of outstanding financial instruments that fail to be timely remarketed in accordance with the principles of the present invention is seen. In the present example, an optional tender is sited in which one or more of the existing Subscribers give notice of tender of Notes as permitted pursuant to an agreement entered by and between the Issuer and the Trustee which governs the administration of the Notes (“Indenture”). The Fiscal Agent is an administrative extension of the Indenture.

As a precursor to operation, the Fiscal Agent establishes the Managed Portfolio Account (201a) pending the issuance of the MVRDN Series for the purposes of holding and managing Managed Note Proceeds equal to the principal portion of Notes being issued and placed. The Reserved Tender Advance Facility will be established either by the Fiscal Agent or by a third party Facility Underwriter for a maximum value up to the aggregate principal portion of outstanding MVRDNs (201b). The Reserved Tender Advance Facility will be expressly available for the purposes of providing short-term credit and liquidity against the eligible investments held in the Managed Portfolio Account once the management and administration of Managed Note Proceeds commences following Note issuance. The Reserved Tender Advance Facility will remain on ‘standby’ until such time as a drawing is received from the Trustee and/or Fiscal Agent. For the purposes of illustration, the present example represents the Reserved Tender Advance Facility as being administered and operated by a third party Facility Underwriter, upon which the Fiscal Agent and/or Trustee may call. Provided the facility is established by the Fiscal Agent as the Facility Underwriter, actions attributable to the Facility Underwriter in the illustration would be performed by the Fiscal Agent.

As was described in reference to FIG. 1, upon issuance and subscription of the Notes, the Managed Note Proceeds are deposited to the Managed Portfolio Account with the Fiscal Agent (202) and the Issuer's operations commence pursuant to the disclosures and descriptions tendered in the Offering Memorandum. Specifically, certain permitted investments or transactions will occur and acquired securities or proceeds there from will be deposited and held for credit to the Managed Portfolio Account.

At some point following the date of subscription, one or more Subscribers exercise their right to optionally tender their Notes, providing notice of, for example, seven (7) day's of such tender to the Trustee in keeping with the terms of the Notes and the Indenture (203). The Trustee gives notice and instruction (204) to the Remarketing Agent to remarket those Notes scheduled for tender prior to the tender date.

Such notice of tender of Notes causes the Remarketing Agent to attempt to resell the tendered Notes prior to any draw upon Managed Note Proceeds by the Trustee (205). Within the permitted timeframe, the Remarketing Agent will customarily have successfully remarketed the Notes being tendered and remarketing proceeds would be applied by the Trustee in satisfaction of the tender. If the Remarketing Agent is unsuccessful in reselling tendered Notes to other third party alternative candidate subscribers (“Candidate Subscribers”), the Issuer is required to repurchase the Notes upon tender from the Subscribers. For the purposes of the present example, it has been assumed that the Remarketing Agent is unsuccessful in timely reselling the tendered Notes and the Candidate Subscribers refused the purchase, thus producing a shortfall of remarketing proceeds required to satisfy the tender. Upon the failure of the Remarketing Agent to timely place the tendered Notes, the Issuer is contacted to repurchase the Notes being tendered. Again, for the purposes of the present example, the Issuer is assumed to not be able to satisfy the tender.

The Trustee is notified (206) of the unavailability of finds sufficient to satisfy the pending tender, and the Trustee calls upon the Fiscal Agent (207) for disbursement of the required funds from the Managed Note Proceeds as may be held in cash as security for the tendered Notes within the Managed Portfolio Account, and/or a draw upon the Reserved Tender Advance Facility; when taken together, the two amounts are equal to an aggregate maximum amount of the remarketing proceeds shortfall up to the principal value of the Notes tendered. The Trustee only calls for funds sufficient to satisfy the pending tender; however, the Trustee may call for an amount up to the principal portion of outstanding Notes as secured for payment by the value of Managed Note Proceeds as held by the Fiscal Agent and the Reserved Tender Advance Facility.

Against the Trustee's call for funds, the Fiscal Agent will determine from which source to draw required proceeds in support of the scheduled tender. For the purposes of this example, the Fiscal Agent has elected to draw required funds against the Reserved Tender Advance Facility (208), leaving the investments which constitute the managed portfolio and any cash proceeds held in the Managed Portfolio Account undisturbed.

Against its receipt of a draw upon the Reserved Tender Advance Facility and notice of which particular Notes are being tendered (which will, upon repurchase with Reserved Tender Advance Facility proceeds, be recorded as Fiscal Agent Notes held for the direct and specific benefit of the Facility Underwriter), the Facility Underwriter will secure (209) its position with a first lien on a par value of investments as held on the Managed Portfolio Account. Such lien will be made active upon the disbursement of the corresponding amount drawn against the Reserved Tender Advance Facility to the Fiscal Agent (210) as the basis to purchase the particular Notes being tendered. The amount drawn under the Reserved Tender Advance Facility is disbursed to the Fiscal Agent; however, at the option of the Fiscal Agent, disbursement of the amount drawn may be made by the Facility Underwriter directly to the Trustee. The Fiscal Agent transfers (211) the funds drawn from the Reserved Tender Advance Facility to the Trustee, plus any other amounts due in satisfaction of the Note tender. The Trustee will disburse (212) to the Subscriber(s) proceeds required to satisfy the tender of Notes, and the Subscriber surrenders (213) the Notes being tendered to the Trustee.

Those tendered Notes that have been repurchased with proceeds derived from the Reserved Tender Advance Facility will be held by the Trustee as Fiscal Agent Notes for the benefit of the Facility Underwriter. The investments as held on the Managed Portfolio Account and upon which the Facility Underwriter has taken a lien, correspond in value to the principal portion of the Fiscal Agent Notes which are the entitlement of the Facility Underwriter. Upon confirmation that Fiscal Agent Notes are held for the benefit of the Facility Underwriter, the value of the Reserved Tender Advance Facility will be reinstated by the Facility Underwriter, thereby permitting the remarketing of the Fiscal Agent Notes as such are supported and secured by the Reserved Tender Advance Facility.

The Remarketing Agent continues to remarket the Fiscal Agent Notes that have been tendered such that the Facility Underwriter may be reimbursed. It may be reasonably assumed that the Notes shall be successfully remarketed by the Remarketing Agent to suitable Candidate Subscribers; however, in one embodiment the Issuer may elect to further mitigate the risk that Notes may not be successfully remarketed by seeking an insurance policy from a suitable insurer specifically designed to cover remarketing risk. Upon the Remarketing Agent's successful remarketing of the Fiscal Agent Notes, remarketing proceeds arising there from will be deposited (214) to the Trustee's Note Purchase Account. The Trustee will transfer (215) the remarketing proceeds arising from the remarketed Fiscal Agent Notes to the Fiscal Agent. The Fiscal Agent will retire (216) the Reserved Tender Advance Facility on behalf of the Issuer with the remarketing proceeds. The Facility Underwriter will release (217) its security interest in any investments held on the Managed Portfolio Account in support of the previously advanced amount as such underlies the Fiscal Agent Notes to which the Underwriter had been entitled. With no further encumbrance on any portion of the Managed Note Proceeds or Eligible Investments, the Reserved Tender Advance Facility will return (218) to its ‘standby’ state until such time as another draw is submitted there against in accordance with the Indenture.

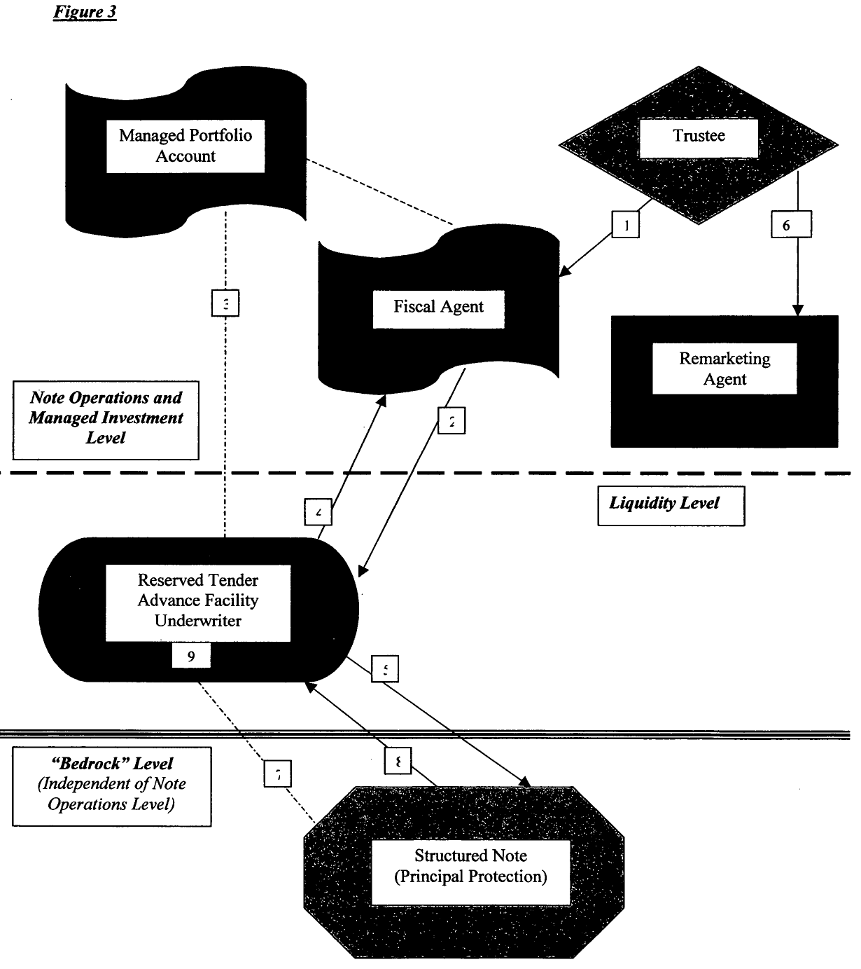

Referring now to FIG. 3, a methodological schematic showing the relationship between the investment operation and the underlying security structure using both the Reserved Tender Advance Facility and a structured note product in the event of investment devaluation in accordance with the principles of the present invention is seen. As has been described in reference to both FIG. 1 and FIG. 2, the utilization of a Reserved Tender Advance Facility serves as the basis to assure liquidity up to the maximum principal amount of outstanding Notes. The Reserved Tender Advance Facility is established with a Facility Underwriter based upon the Facility Underwriter's knowledge of the nature of investments being proposed to be undertaken by the Issuer.

The formulation of an acceptable investment operation is accomplished with a candidate Facility Underwriter, by way of example, the negotiation and definition of: specific investment eligibility criteria that serves as the ‘blanket’ investment and credit policy applicable to the managed portfolio; the establishment of an investment draw schedule during the life of the Notes that may require certain minimum cash values be maintained on certain designated or nominated accounts up to the date of scheduled final maturity; the allocation of a certain percentage of investment earnings, profits or yields arising from the investments during the term of the Notes into a dedicated reserve account to be held by the Facility Underwriter; the granting of a security interest in certain accounts and assets in favor of the Facility Underwriter; the granting of a security interest in other additional collateral deemed acceptable to the Facility Underwriter in support of the establishment and maintenance of the Reserved Tender Advance Facility underlying the Managed Portfolio Account operations; and/or the establishment of certain third party insurance of remarketing operations that assures any mandatory or optionally tendered Notes are successfully resold.

Examples of specific investment eligibility criteria may be defined pursuant to specific formulas which identify: certain managed portfolio diversification criteria or the implementation of non-correlating investment strategies or profiles, specific minimum historical performance ratios for a given type of investment, required percentage-based cash reserve requirements which may be deposited with and held by the Facility Underwriter during the life of a subject investment, the creation of a sinking fund to directly offset and compensate the Facility Underwriter for the maximum perceived potential loss of asset value during the life of a given investment or as the basis to offset and cover Reserved Tender Advance Facility fees or expenses to be incurred.

The basis of negotiating and securing the establishment and maintenance of the Reserved Tender Advance Facility may include any one or more of the aforementioned mechanisms or such other mechanism as a specific Facility Underwriter may warrant and a specific Issuer may grant. In any event, in securing the Reserved Tender Advance Facility the formulation of investment criteria is established which sufficiently supports the valuation of the available assets at Note maturity, inclusive of the investment portfolio itself and any cash reserves or earnings generated or arising from such cash reserves which may be scheduled or accrued during the term of the Notes. Thus, the Facility Underwriter may operate the facility solely in support of the Trustee for the benefit of the Note Holders of the Notes which have been sold via the offering and is not being engaged for the purposes of guaranteeing specific performance of the Notes. Rather, the Reserved Tender Advance Facility expressly becomes operative to secure the principal portion of the Notes outstanding against investments held on the Managed Portfolio Account.

The Reserved Tender Advance Facility, as a stand-alone support for the principal portion of the Notes, is sufficient to act as a credit enhancement of the Notes given the Facility Underwriter is a banking institution having an acceptable investment grade rating of its obligations. The rating of the Facility Underwriter will become, in part, the basis by which the creditworthiness of the Notes is measured. Thus, the Reserved Tender Advance Facility itself is sufficient to credit enhance and support the investment grade rating of the Notes. However, as a practical matter, the establishment of the facility thus hinges the investment, credit, and market risk for the operation of the Managed Portfolio Account on the Facility Underwriter. Such a circumstance may from time to time be deemed unacceptable to the Facility Underwriter. In such case, as a means of defraying risks that may result in the potential devaluation of the managed portfolio to a value less than the principal portion of outstanding Notes, a structured note product may be created that underlies the operation of the Reserved Tender Advance Facility as a supplemental source of repayment (“Bedrock Note”) to the Facility Underwriter. The Bedrock Note is not a necessary component to enable the operation of the Notes; however, the Bedrock Note offers a risk management alternative to the Facility Underwriter that can more readily support the establishment of the facility for the benefit of the Note Holders without becoming a visible component to the Note itself.

The Issuer of the Bedrock Note may be the Fiscal Agent or a third party institution that may act as a nominated Paying Agent on behalf of the Fiscal Agent and which credit rating is acceptable to the Facility Underwriter. The Bedrock Note would have a maximum term or maturity equal to the maturity of the Notes, although a party skilled in the art may elect to issue the Bedrock Note for such shorter incremental term as may be acceptable to the Facility Underwriter. The Bedrock Note, although dubbed a ‘note’ may take the form of an alternative payment undertaking or obligation of the Bedrock Note Issuer, but in any event, such undertaking will act to minimally guarantee the original principal value of the Managed Portfolio Account for the benefit of the Facility Underwriter at its maturity. This alternative source of supplemental security becomes most relevant in the event the Reserved Tender Advance Facility has been drawn for an amount equal to the par value of all outstanding Notes at a time when the investments held in the Managed Portfolio Account are for any reason undervalued and insufficient additional collateral is available to the Facility Underwriter to offset such depreciated value. The issuance of the Bedrock Note may be induced in a variety of ways, including but not limited to the allocation of a portion of the Managed Note Proceeds with the Bedrock Note Issuer to manage on behalf of the Issuer, or the deposit of acceptable cash, securities or collateral with the Bedrock Note Issuer as security for the Bedrock Note.

For the purpose of illustration, in the event of an optional or mandatory tender of outstanding Notes with a complete failure of the Remarketing Agent to remarket any portion of the tendered Notes timely, the Trustee will instruct (301) the Fiscal Agent to release funds sufficient to satisfactorily repurchase the principal amount of Notes tendered. The Fiscal Agent will draw (302) upon the maximum value of the Reserved Tender Advance Facility for an amount equal to the principal amount of Notes outstanding. Pursuant to the processes described in reference to FIG. 2, the Facility Underwriter will secure (303) its position by placing a lien on the investments held on the Managed Portfolio Account. Again, assume for the purposes of illustration that due to market conditions, the value of the assets on the Managed Portfolio Account has unexpectedly dropped below the principal amount of Notes outstanding and, therefore, below the amount then being drawn against the Reserved Tender Advance Facility. The Facility Underwriter will disburse (304) the amount drawn against the Reserved Tender Advance Facility; however, the Reserved Tender Advance Facility is then undercollateralized for amounts disbursed.

The Facility Underwriter will, as and if required, advise (305) the Bedrock Note Issuer of the shortfall and secure itself against the Bedrock Note for the balance of amounts due for reimbursement upon the Facility Underwriter's disbursement of amounts drawn against the Bedrock Note. As described in reference to FIG. 2, upon notice from the Trustee, the Remarketing Agent will undertake to remarket (306) the Fiscal Agent Notes that have been purchased with the amount drawn against the Reserved Tender Advance Facility. However, again, for the purposes of illustration, assume that the Fiscal Agent Notes fail to be remarketed at any time and no third party remarketing insurance has been organized by the Issuer. In such event, the Facility Underwriter will secure (307) itself for amounts to be reimbursed to it against the amount payable upon the maturity of the Bedrock Note. Thus, the Facility Underwriter has provided needed liquidity to satisfy a Note tender and by use of the Bedrock Note has reduced its exposure in the transaction to substantially duration risk until the maturity/redemption date of the Bedrock Note. Upon maturity of the Bedrock Note, the Facility Underwriter will have recovered (308) its position as disbursed upon the Trustee's draw against the Reserved Tender Advance Facility. The Reserved Tender Advance Facility is thereafter retired (309).

While the invention has been described with specific embodiments, other alternatives, modifications, and variations will be apparent to those skilled in the art. For example, depending on the particular needs of an investment a financial instrument in accordance with the present investment can be combined with other financial instruments in a single offering. Accordingly, it will be intended to include all such alternatives, modifications and variations set forth within the spirit and scope of the appended claims.

The following Glossary of Terms is set forth for convenience and should not be construed as limiting the scope of the present invention:

### Glossary of Terms:

Bedrock Note: a structured note product that may be used to underlie and further secure the interests of the Facility Underwriter in the event of a devaluation of the permitted investments in the Managed Portfolio Account.

Candidate Subscribers: other third party alternative subscribers to whom the Remarketing Agent offers to resell the Notes following a permitted tender of the Notes by an existing Subscriber.

Collateralized Variable Rate Demand Note (CVRDN): short-term floating rate debt instruments that permits a debt-based pool to be raised prior to making specific investment allocations; may be credit enhanced by application of a bank letter of credit or a municipal bond insurance policy covering interest and principal.

Custodial Account: the safekeeping account established at the Trustee's institution for the purposes of holding the Interest Letter of Credit for the benefit of the Note Holders.

Fiscal Agent: a banking institution with trust powers or trust company having a credit agency rating of its long-term obligations of sufficient quality to meet minimal rating criteria set forth by the nominated credit rating agency which rates the Notes; acts as the administrator for the management of the Managed Portfolio Account under certain guidelines and paying agent on behalf of the Issuer related to the Reserved Tender Advance Facility.

Fiscal Agent Notes: those tendered Notes that have been repurchased with proceeds arising from a draw against the Reserved Tender Advance Facility.

Facility Underwriter: This entity may consist of one or several international banking institutions, insurers or functionally comparable entities; however, in general there is a lead underwriting institution of sufficient credit quality (its credit rating according to S&P or Moody's) to meet minimal rating criteria set forth by the nominated credit rating agency which subsequently rates the Notes. The Facility Underwriter is engaged for the purposes of establishment of the Reserved Tender Advance Facility in support of the principal portion of the Notes.

Indenture: the agreement entered by and between the Issuer and the Trustee which governs the administration of the Notes.

Interest Guarantor: the issuer of the Interest Letter of Credit.

Interest Letter of Credit: the letter of credit that secures the payment of interest due under the Notes; usually issued as a direct-pay letter of credit.

Issuer: a bankruptcy remote special purpose entity which issues the Notes, makes the offering for the purpose of attracting investment and subsequently manages and implements the proceeds of the sale of the Notes in a manner consistent with investment criteria established upon Note issuance and as stated in that certain Offering Memorandum.

Managed Note Proceeds: those Note proceeds which are placed on deposit in the Manage Portfolio Account(s) for the purpose of securing the principal portion of the Notes whilst operating the investment operations set forth by the Issuer in that certain Offering Memorandum.

Managed Portfolio Account: one or more interest bearing, depository/investment account(s) at the Fiscal Agent's institution designated for the reservation and holding of funds in support of the operation of the Issuer's alternative investment fund, cash or asset management operations, or securities or commodities trading functions.

Managed Variable Rate Demand Notes (MVRDNs): an example of a financial instrument in accordance with the principles of the present invention.

Note: the financial instrument being offered for sale to the institutional capital markets in accordance with the principles of the present invention.

Note Holders: the subscribers; the owners of the Notes which have been sold via the offering.

Offering Memorandum: the document which provides the potential investor with a required description of and disclosure related to the nature of the Notes being offered for sale.

Premium: supplemental Note earnings beyond interest payable in favour of the Subscribers and/or any other entities entitled to participate therein over a prescribed term.

Private Placement: the entity which is expressly responsible for the marketing of the offering on behalf of the Issuer.

Remarketing Agent: the entity that is engaged at the time of offering of any alternative entity substituted therefore at any time subsequent thereto for the remarketing or resale of any tendered Notes during the life of the Notes.

Reserve Tender Advance Facility: a liquidity/credit facility secured by the Managed Portfolio Account that is established with a banking institution or other financial institution having a credit agency rating of its long-term obligations of sufficient quality to meet minimal rating criteria set forth by the nominated credit rating agency which rates the Notes;

Subscribers: those entities, parties or individuals who purchase the Notes, consisting primarily of institutional investors (such as for example money market funds), corporations, trust departments and, to a lesser extent, high net worth individuals.

Trustee: the entity responsible for the administration of the Notes for the benefit of the Issuer and the Note Holders throughout the life of the Notes; governed by the terms and conditions of the Indenture executed with the Issuer.

Variable Rate Demand Notes (VRDNs): short-term floating rate debt instruments that may be credit enhanced by application of a bank letter of credit or a municipal bond insurance policy.

What is claimed is:

1. A method of financing comprising:
offering a financial instrument for the purpose of attracting investment;
pooling proceeds from the financial instrument to be used for the purposes of permitted asset management;
actively deploying the debt capital into permitted investments without the introduction of a third party source of security or collateral to cover the funds being deployed as a predicate to effectuating those investment operations; and
managing and employing the proceeds of the sale of the financial instrument in a manner consistent with generic investment criteria as established related to that certain offering.

2. The method of financing of claim 1 further wherein the step of pooling proceeds from the financial instrument comprises pooling proceeds from the financial instrument to be used for the purposes of permitted investment.

3. The method of financing of claim 2 further wherein the step of pooling proceeds from the financial instrument comprises pooling proceeds from the financial instrument to be used for the purposes of permitted investment by an investor selected from the group comprising asset managers, cash managers, alternative investment funds, hedge funds, trading firms, and combinations thereof.

4. The method of financing of claim 1 further including! establishing a special purpose entity to issue the financial instrument.

5. The method of financing of claim 1 further wherein the step of actively deploying the debt capital into permitted investments comprises actively deploying the debt capital into permitted investments without the introduction of a letter of credit to cover the funds being deployed as a predicate to effectuating those investment operations.

6. The method of financing of claim 1 further including securing the payment of interest accruing on the financial instrument.

7. The method of financing of claim 6 further including securing the payment of interest accruing on the financial instrument with a letter of credit.

8. The method of financing of claim 1 further including paying a premium based upon performance of the generic investment criteria.

9. The method of financing of claim 1 further including placing proceeds from the financial instrument on deposit in an account in such manner so as to ensure the bankruptcy remote status of such proceeds from an entity offering the financial instrument.

10. The method of financing of claim 1 further including initially rating the financial instrument by a credit rating agency based upon a third party source of security or collateral securing the payment of interest on the financial instrument.

11. The method of financing of claim 10 further including initially rating the financial instrument by a credit rating agency based upon a letter of credit that secures the payment of interest on the financial instrument.

12. The method of financing of claim 1 further including initially rating the financial instrument by a credit rating agency based upon structures employed that act as a credit enhancement mechanism covering the principal portion of the financial instrument.

13. The method of financing of claim 12 further including initially rating the financial instrument by a credit rating agency based upon a letter of credit that secures the payment of interest on the financial instrument.

14. A method of financing comprising:
offering a financial instrument for the purpose of attracting investment;
placing proceeds from the financial instrument on deposit in an account;
actively deploying the proceeds from the financial instrument into permitted investments without the introduction of a third party source of security or collateral to cover the proceeds of the financial instrument being deployed as a predicate to effectuating those permitted investment operations;
managing and employing the proceeds of the sale of the financial instrument in a manner consistent with generic investment criteria established related to that certain offering; and
paying a premium based upon performance of the generic investment criteria.

15. The method of financing of claim 14 further wherein the step of placing proceeds from the financial instrument on deposit in an account comprises pooling proceeds from the financial instrument to be used for the purposes of permitted investment.

16. The method of financing of claim 15 further including investing investment selected by the group comprising asset managers, cash managers, alternative investment funds, hedge funds, trading firms, and combinations thereof.

17. The method of financing of claim 14 further including establishing a special purpose entity to issue the financial instrument.

18. The method of financing of claim 14 further wherein the step of actively deploying debt capital into permitted investments comprises actively deploying the debt capital into permitted investments without the introduction of a letter of credit to cover the funds being deployed as a predicate to effectuating those investment operations.

19. The method of financing of claim 14 further including securing the payment of interest accruing on the financial instrument.

20. The method of financing of claim 19 further including securing the payment of interest accruing on the financial instrument with a letter of credit.

21. The method of financing of claim 14 further including placing proceeds from the financial instrument on deposit in an account in such manner so as to ensure the bankruptcy remote status of such proceeds from an entity offering the financial instrument.

22. The method of financing of claim 14 further including initially rating the financial instrument by a credit rating agency based upon a third party source of security or collateral securing the payment of interest on the financial instrument.

23. The method of financing of claim 14 further including initially rating the financial instrument by a credit rating agency based upon structures employed that act as a credit enhancement mechanism covering the principal portion of the financial instrument.

24. The method of financing of claim 14 further including establishing a liquidity facility that is secured by the proceeds of the financial instrument and any subsequent permitted investments that are undertaken therewith.

25. The method of financing of claim 14 further including establishing a structured note product to mitigate risks associated with operation of the liquidity facility in the event of a market depreciation of the value of permitted investments of the proceeds of the financial instrument.

26. The method of financing of claim 25 further including establishing the structured note product based in part upon the nature of the investment strategies employed and implemented.

27. The method of financing of claim 25 further including establishing the structured note product independently from the operation of the financial instrument terms as reflected to the investor.

28. A method of financing comprising:
offering a financial instrument for the purpose of attracting investment;
placing proceeds from the financial instrument in an account;
actively deploying the proceeds from the financial instrument into permitted investments without the introduction of a third party source of security or collateral to cover the proceeds from the financial instrument being deployed as a predicate to effectuating those investment operations;
managing and employing the proceeds of the sale of the financial instrument in a manner consistent with generic investment criteria established related to that certain offering; and
mitigating risk associated through the introduction of a structured note product that underlies the financial instrument without directly effecting the functionality and collateral structures of the financial instrument.

29. The method of financing of claim 28 further wherein the step of placing proceeds from the financial instrument in an account comprises pooling proceeds from the financial instrument to be used for the purposes of permitted investment.

30. The method of financing of claim 28 further wherein the step of actively deploying the debt capital into permitted investments comprises actively deploying the debt capital into permitted investments without the introduction of a letter of credit to cover the finds being deployed as a predicate to effectuating those investment operations; and

31. The method of financing of claim 28 further including placing proceeds from the financial instrument on deposit in an account in such manner so as to ensure the bankruptcy remote status of such proceeds from an entity offering the financial instrument.
